(19) United States
(12) Patent Application Publication
(10) Pub. No.: US 2016/0272018 A1
(43) Pub. Date: Sep. 22, 2016

(54) RETROFITTABLE TIRE PRESSURE MONITORING SYSTEM

(71) Applicant: Danny Duong, Coachella, CA (US)

(72) Inventor: Danny Duong, Coachella, CA (US)

(21) Appl. No.: 14/664,060

(22) Filed: Mar. 20, 2015

(51) Int. Cl. B60C 23/02

(52) U.S. Cl. CPC B60C 23/02

(57) ABSTRACT

A retrofittable tire pressure monitoring system includes a vehicle having an interior. A plurality of tires is provided and at least some of the plurality of tires is mounted on the vehicle. A plurality of pressure detecting assemblies are provided and each of the tires has one of the pressure detecting assemblies mounted thereto and each is in fluid communication with an interior of an associated one of the tires. Each of the pressure detecting assemblies detects an air pressure level within the associated one of the tires. A warning assembly is in remote communication with the pressure detecting assemblies and provides at least visual warnings that one or more of the pressure detecting assemblies has detected air pressure below a threshold pressure. The warning assembly is portable and is movable within the vehicle.

### BACKGROUND OF THE DISCLOSURE

### Field of the Disclosure

The disclosure relates to tire pressure monitoring devices and more particularly pertains to a new tire pressure monitoring device for indicating when the tires of a vehicle or other wheeled device have low air pressure.

### SUMMARY OF THE DISCLOSURE

An embodiment of the disclosure meets the needs presented above by generally comprising a vehicle having an interior. A plurality of tires is provided and at least some of the plurality of tires is mounted on the vehicle. A plurality of pressure detecting assemblies are provided and each of the tires has one of the pressure detecting assemblies mounted thereto and each is in fluid communication with an interior of an associated one of the tires. Each of the pressure detecting assemblies detects an air pressure level within the associated one of the tires. A warning assembly is in remote communication with the pressure detecting assemblies and provides at least visual warnings that one or more of the pressure detecting assemblies has detected air pressure below a threshold pressure. The warning assembly is portable and is movable within the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a retrofittable tire pressure monitoring system according to an embodiment of the disclosure.

FIG. 2 is a rear perspective view of a base of an embodiment of the disclosure.

FIG. 3 is a rear perspective view of a pressure sensing assembly of an embodiment of the disclosure.

FIG. 4 is a perspective in-use view of an embodiment of the disclosure.

FIG. 5 is a schematic view of an embodiment of the disclosure.

### DESCRIPTION OF THE PREFERRED EMBODIMENT

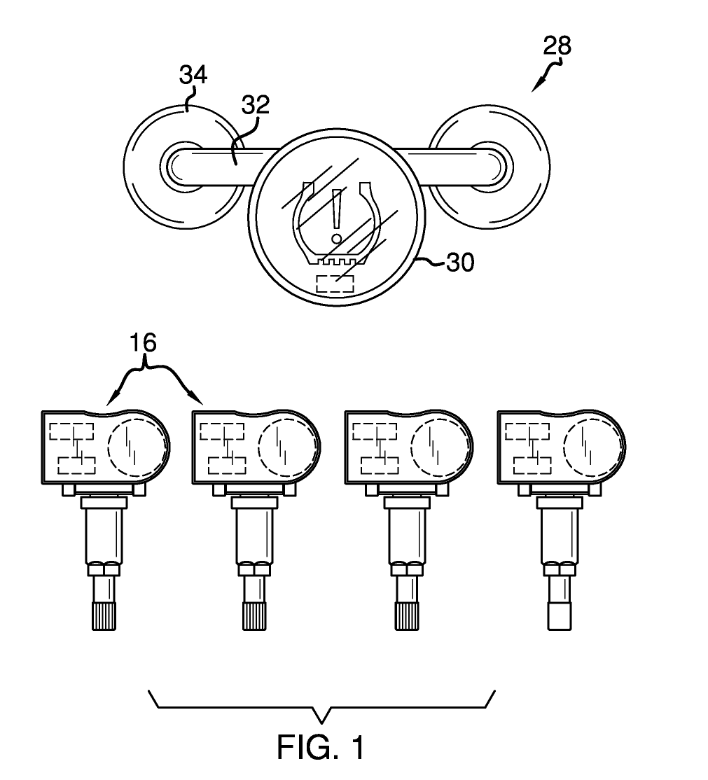

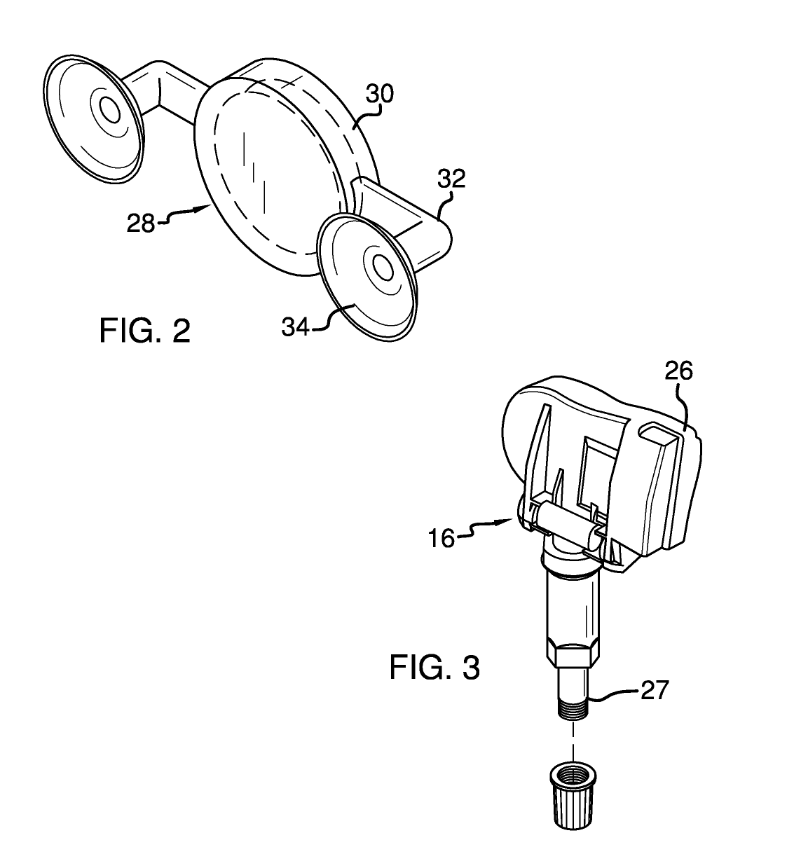

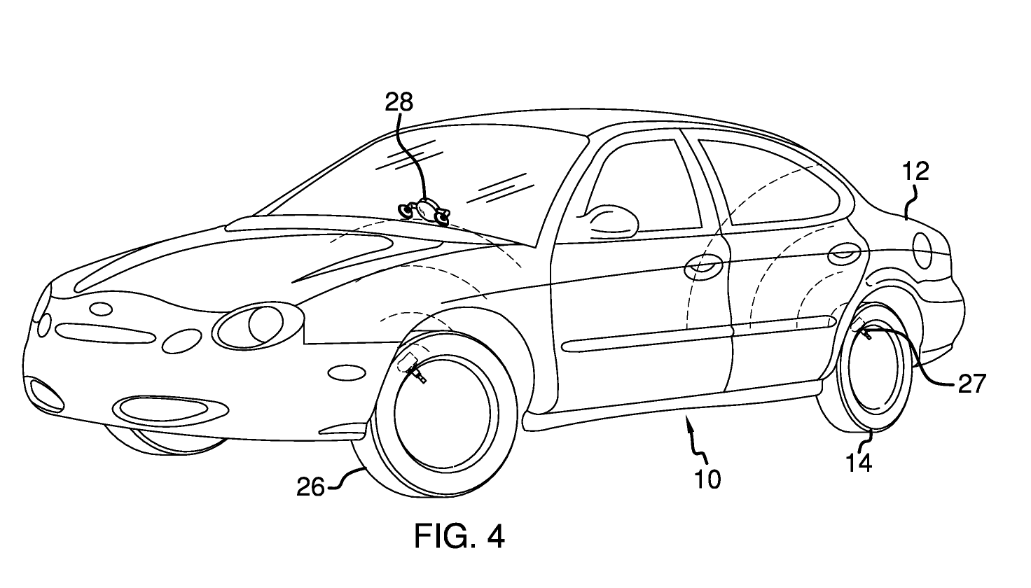

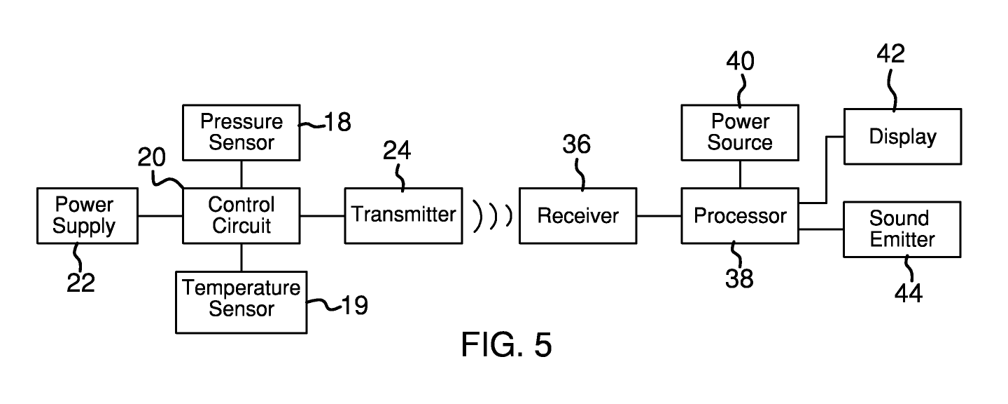

With reference now to the drawings, and in particular to FIGS. 1 through 5 thereof, a new tire pressure monitoring device embodying the principles and concepts of an embodiment of the disclosure and generally designated by the reference numeral 10 will be described.

As best illustrated in FIGS. 1 through 5, the retrofittable tire pressure monitoring system 10 generally comprises a vehicle 12 has an interior. The vehicle 12 may be any conventional vehicle. A plurality of tires 14 is provide and at least some of the plurality of tires 14 is mounted on the vehicle 12. The tires 14 of the current system 10 may also be on trailers or other wheeled objects which are attached to the vehicle 14.

A plurality of pressure detecting assemblies 16 is provided. Each of the tires 14 has one of the pressure detecting assemblies 16 mounted thereto and in fluid communication with an interior of an associated one of the tires 14. Each of the pressure detecting assemblies 16 is configured to detect an air pressure level within the associated one of the tires 14.

Each of the pressure detecting assemblies 16 includes an air pressure sensor 18 that is positioned within the tire 14. A control circuit 20 is electrically coupled to the air pressure sensor 18 and a power supply 22 electrically coupled to the control circuit 22. The power supply 22 may comprise a conventional battery. A transmitter 24 is electrically coupled to the control circuit 20 and is capable of transmitting a wireless signal. The wireless signal will be of short range, typically less than 100 feet. The control circuit 20 is programmed actuate the transmitter 24 to wirelessly transmit a warning signal when the air pressure sensor 18 detects an air pressure below a threshold pressure. The warning signal may be discrete and differentiated to each one of the pressure detecting assemblies. That is, each pressure detecting assembly 16 may have its only unique signal such that they can be differentiated from each other. The threshold pressure, as is known in the art, will vary depending on the tire 14 and the object on which it is mounted. A housing 26 contains each of the air pressure sensor 18, control circuit 20, power supply 22 and transmitter 24. The housing 26 will typically be positioned within the tire 14 and may be mounted to an interior surface of a side wall of the tire 14. A valve stem 28 extends through the tire 14 and is in fluid communication with an exterior of the associated one of the tires 14. The valve stem 27 allows a user of the system 10 to add air to the tire 14 in a conventional fashion. The valve stem 27 is attached to the housing 26.

Additionally, each of the detecting assemblies 16 may include a temperature sensor 19 electrically coupled to the control circuit 20 for detecting a rise in temperature of a tire 14. When a tire 14 goes flat, the temperature of the tire 14 will increase rapidly due to friction between the tire 14 and the ground surface and rim on which the tire 14 is mounted. The control circuit 20 may transmit the warning signal when either the temperature has risen above an acceptable level or the temperature rises at an unacceptable rate. Since a tire 14 may be manufactured with various tolerances, the exact temperature threshold and rate of temperature increase will be pre-determined and the control circuit programmed with this data.

A warning assembly 28 is in remote communication with the pressure detecting assemblies 16 and provides at least visual warnings that one or more of the pressure detecting assemblies 16 has detected air pressure below the threshold pressure. The warning assembly 28 is portable and is movable within the vehicle 12. This allows the system 10 to be more readily retrofitted to a vehicle 12 while also providing the user with the option of placement of the warning assembly 28.

The warning assembly includes a base 30 and a mount 32 that is attached to the base 30 to removably mount the base 30 to the vehicle 12. The mount 32 may include at least one suction cup 34 attached to the base 30 and so that the base 30 is removably couplable to a window, such as a windshield, of the vehicle 12. A receiver 36 is mounted in the base 30 and is configured to receive signals to from the pressure detecting assemblies 16. A processor 38 is mounted in the base 30 and is electrically coupled to the receiver 36. A power source 40, such as a battery, is mounted in the base 30 and is electrically coupled to the processor 38. A display 42 is mounted on the base 30 and is electrically coupled to the processor 38. The display 42 may be a conventional LCD, LED or similar type display. The display 42 displays low pressure indicia when the receiver receives the warning signal. As indicated above, the display 42 may further display indicator indicia indicating which of the pressure detecting assemblies 16 has transmitted the warning signal. Though shown as a phantom box, this area may indicate a number, letter or other indicia to indicate which pressure detecting assembly 16 the warning is associated with. A sound emitter 44 may be mounted to the base and is electrically coupled to the processor 38. The sound emitter 44 emits an audible sound when the receiver 36 receives the warning signal. It should be understood that that control circuit 20 may continuously send information to the processor 38 wherein the processor is programmed to determine if pressure or temperature thresholds have been exceeded and will actuator warning indicators if those thresholds are met.

In use, the system 10 is mounted to tires 14 and the base positioned where the user of the system 10 may readily be warned that one or more tires 14 has suffered a loss of air pressure, or is otherwise too low, or if the temperature has risen beyond an acceptable level. The user will thereby be warned to stop the vehicle 12 and inspect and add air to the affected tire(s) 14. Because the system 10 is retrofitted to an existing vehicle 12 and tire 14, the system 10 is easily used with trailers being towed by the vehicle 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tire pressure monitoring system configured to be retrofitted onto one or more tires, said system comprising:
a vehicle having an interior;
a plurality of tires, at least some of said plurality of tires being mounted on said vehicle;
a plurality of pressure detecting assemblies, each of said tires having one of said pressure detecting assemblies mounted thereto and being in fluid communication with an interior of an associated one of said tires, each of said pressure detecting assemblies being configured to detect an air pressure level within said associated one of said tires; and
a warning assembly being in remote communication with said pressure detecting assemblies and providing at least visual warnings that one or more of said pressure detecting assemblies has detected air pressure below a threshold pressure, said warning assembly being portable and being movable within said vehicle.

2. The tire pressure monitoring system according to claim 1, wherein each of said pressure detecting assemblies includes:
an air pressure sensor, said air pressure sensor being positioned within said tire;
a control circuit being electrically coupled to said air pressure sensor;
a power supply electrically coupled to said control circuit;
a transmitter being electrically coupled to said control circuit, said control circuit being programmed actuate said transmitter to wirelessly transmit a warning signal when said air pressure sensor detects an air pressure below a threshold pressure;
a housing containing each of said air pressure sensor, control circuit, power supply and transmitter; and
a valve stem extending through said tire and being in fluid communication with an exterior of the associated one of said tires, said valve stem being attached to said housing.

3. The tire pressure monitoring system according to claim 2, wherein said warning signal is discrete and differentiated to each one of said pressure detecting assemblies, said warning assembly indicating which of said pressure detecting assemblies has transmitted said warning signal.

4. The tire pressure monitoring system according to claim 1, wherein said warning assembly includes:
a base;
a mount being attached to said base to removably mount said base to said vehicle;
a receiver being mounted in said base and being configured to receive signals to from said pressure detecting assemblies;
a processor being mounted in said base and being electrically coupled to said receiver;
a power source being mounted in said base and being electrically coupled to said processor; and
a display being mounted on said base and being electrically coupled to said processor, said display displaying low pressure indicia when said receiver receives a warning signal from one of said pressure detecting assemblies.

5. The tire pressure monitoring system according to claim 4, wherein said warning signal is discrete to each of said pressure detecting assemblies, said display further displaying an indicator indicia indicating which of said pressure detecting assemblies has transmitted said warning signals.

6. The tire pressure monitoring system according to claim 4, further including a sound emitter being mounted to said base and being electrically coupled to said processor, said sound emitter emitting an audible sound when said receiver receives said warning signal.

7. The tire pressure monitoring system according to claim 4, wherein said mount includes at least one suction cup attached to said base and being removably couplable to a window of said vehicle

8. A tire pressure monitoring system configured to be retrofitted onto one or more tires, said system comprising:
a vehicle having an interior;
a plurality of tires, at least some of said plurality of tires being mounted on said vehicle;
a plurality of pressure detecting assemblies, each of said tires having one of said pressure detecting assemblies mounted thereto and being in fluid communication with an interior of an associated one of said tires, each of said pressure detecting assemblies being configured to detect an air pressure level within said associated one of said tires, each of said pressure detecting assemblies including:
an air pressure sensor, said air pressure sensor being positioned within said tire;
a control circuit being electrically coupled to said air pressure sensor;
a power supply electrically coupled to said control circuit;
a transmitter being electrically coupled to said control circuit, said control circuit being programmed actuate said transmitter to wirelessly transmit a warning signal when said air pressure sensor detects an air pressure below a threshold pressure;
a housing containing each of said air pressure sensor, control circuit, power supply and transmitter;
a valve stem extending through said tire and being in fluid communication with an exterior of the associated one of said tires, said valve stem being attached to said housing;
wherein said warning signal is discrete and differentiated to each one of said pressure detecting assemblies;
a warning assembly being in remote communication with said pressure detecting assemblies and providing at least visual warnings that one or more of said pressure detecting assemblies has detected air pressure below said threshold pressure, said warning assembly being portable and being movable within said vehicle, said warning assembly including:
a base;
a mount being attached to said base to removably mount said base to said vehicle, said mount including at least one suction cup attached to said base and being removably couplable to a window of said vehicle;
a receiver being mounted in said base and being configured to receive signals to from said pressure detecting assemblies;
a processor being mounted in said base and being electrically coupled to said receiver;
a power source being mounted in said base and being electrically coupled to said processor;
a display being mounted on said base and being electrically coupled to said processor, said display displaying low pressure indicia when said receiver receives said warning signal, said display further displaying an indicator indicia indicating which of said pressure detecting assemblies has transmitted said warning signal; and
a sound emitter being mounted to said base and being electrically coupled to said processor, said sound emitter emitting an audible sound when said receiver receives said warning signal.
